(19) United States
(12) Patent Application Publication
(10) Pub. No.: US 2006/0003887 A1
(43) Pub. Date: Jan. 5, 2006

(54) Catalyst-containing clay materials for composites in polymer of macrocyclic oligomers

(76) Inventors: Michael Steven Paquette, Midland, MI (US); Robert Paul Dion, Midland, MI (US); Peter Charles LeBaron, Midland, MI (US); Robert Louis Sammler, Midland, MI (US); Yu Liu, Midland, MI (US)

Correspondence Address: GARY C. COHN, PLLC, 1147 NORTH FOURTH STREET, UNIT 6E, PHILADELPHIA, PA, 19123, US

(21) Appl. No.: 11/154,016

(22) Filed: Jun. 16, 2005

Related U.S. Application Data
(60) Provisional application No. 60/581,152, filed on Jun. 18, 2004.

(51) Int. Cl. C04B 33/00

(52) U.S. Cl. 501/141

(57) ABSTRACT

Clays useful as fillers for preparing nanocomposites are combined with a polymerization catalyst by mixing the clay and the catalyst, generally in the presence of a diluent. The catalyst at least partially intercalates the clay or becomes chemically bonded to the clay. The catalyst-containing clays are then useful for preparing composites of the clay in polymers of a macrocyclic oligomer, by dispersing the clays into the oligomers and subsequently polymerizing the oligomer.

### CROSS-REFERENCE TO RELATED APPLICATION

This application claims benefit of U.S. Provisional Application No. 60/581,152, filed 18 Jun. 2004.

### BACKGROUND OF THE INVENTION

The invention relates to polymers derived from macrocyclic oligomers containing organoclay fillers. The invention also relates to processes for preparing such compositions, and to a catalyst-containing clay that is useful in preparing such compositions. Furthermore, the invention relates to articles prepared from organoclay filled polymer compositions.

Macrocyclic oligomers have been developed that form polymeric compositions with desirable properties such as strength, toughness, high gloss and solvent resistance. Among preferred macrocylic oligomers are macrocyclic polyester such as those disclosed in U.S. Pat. No. 5,498,651, incorporated herein by reference. Such macrocyclic polyester oligomers are excellent starting materials for producing polymer composites because they exhibit low melt viscosities, which facilitate good impregnation and wet out in composite applications. Furthermore, such macrocyclic oligomers are easy to process using conventional processing techniques. However, such polymer compositions do not have heat deflection temperatures that are high enough to permit them to be suitable for some high-temperature applications. Therefore, nanocomposites of such materials have been developed wherein layered clay platelets are dispersed in the polymeric matrix. Such compositions are disclosed in U.S. Pat. No. 5,530,052 and in WO 04/058868, both incorporated herein by reference.

The dispersed clays in these nanocomposites provide improved thermal properties and reinforcement to the polymer, while other properties such as ductility are maintained at acceptable levels. This property enhancement depends greatly on the extent to which the clay becomes exfoliated and distributed uniformly throughout the polymer. Therefore, methods by which the clay particles can be distributed efficiently and more evenly throughout the polymer matrix are highly desirable.

### SUMMARY OF THE INVENTION

In one aspect, this invention is a process for preparing a nanocomposite of clay platelets in a polymer of a macrocyclic oligomer, comprising
a) forming a catalyst-containing, layered clay
b) combining the catalyst-containing layered clay with a macrocyclic oligomer;
c) polymerizing the macrocyclic oligomer in the presence of the catalyst-containing layered clay.

This process provides a method by which excellent dispersion of the clay into the polymer phase can be achieved. The excellent dispersion in turn allows for a higher degree of exfoliation of the clay within the polymer matrix, resulting in very efficient reinforcement and other improvements in the physical properties of the polymer.

In another aspect, this invention is a layered clay containing a macrocyclic oligomer polymerization catalyst. In a third aspect, this invention is a method of forming a layered clay containing a macrocyclic oligomer polymerization catalyst, comprising contacting the clay with a macrocyclic oligomer polymerization catalyst in the presence of a diluent that swells the clay but is otherwise inert to the clay.

This catalyst-containing clay is an excellent starting material for forming composites of the clay in a polymerized macrocyclic oligomer. The layers of the catalyst-containing clay material are in some embodiments measurably more widely separated than in the unmodified clay. This wider layer-to-layer spacing is believed to facilitate the penetration of additional macrocyclic oligomer between the clay layers, thus enhancing the further dispersion and distribution of the clay into the polymer during subsequent blending and/or polymerization operations. In addition, the presence of the catalyst in the clay is believed to promote polymerization reactions, and therefore polymer chain growth, between the clay layers, further contributing to the dispersion and distribution of the clay.

### DETAILED DESCRIPTION OF THE INVENTION

The catalyst-containing layered clay is conveniently prepared by forming a slurry of the clay in a diluent, which is preferably a solvent for the catalyst. No such diluent is necessary if the catalyst is a liquid; however, it is preferred to use a diluent, especially if it is desired that the catalyst become chemically bonded to the clay, as described more below. The ratio of diluent to catalyst can vary widely, such as from about 1 part clay per 100 parts diluent to about 1 part diluent per 10 parts clay (all parts being by weight). A typical amount of diluent is about 0.5 parts to about 50 parts by weight diluent to 1 part by weight clay. A preferred amount of diluent is about 5 to about 30 parts by weight diluent per part by weight clay.

The clay/diluent slurry is conveniently prepared by simple mixing, with agitation, at any temperature below the boiling temperature or decomposition temperature of the diluent. It is generally not necessary to heat the diluent or mixture in order to prepare the slurry, although that can be done if desired. Temperatures of from about 0 to about 50° C. are generally preferred, and temperatures of from about 20 to about 40° C. are particularly useful. The clay can be added to the diluent, or vice-versa. When the clay is added to the diluent, the clay may be added all at once, continuously or in two or more increments. Similarly, when the diluent is added to the clay, it may be added all at once, continuously or in two or more increments. As or after the clay and diluent are combined, they are mixed to swell the clay or, preferably, create a dispersion of the clay in the diluent. Mixing is preferably continued until a roughly homogeneous dispersion is obtained, from which the clay does not significantly settle.

The clay/diluent slurry is contacted with the polymerization catalyst. This can be performed at the same time the clay/diluent slurry is prepared, by pre-mixing the polymerization catalyst into the diluent, or by adding all three components together as separate streams. It is also possible to first form the clay/diluent slurry, and subsequently add the polymerization catalyst. The polymerization catalyst can be added neat or mixed with or dissolved in the diluent. Order of addition is generally not critical, although it is preferable to prepare the clay/diluent slurry first (followed by polymerization catalyst addition), or by adding the clay to a previously-formed solution of the polymerization catalyst in the diluent.

If the polymerization catalyst is added to a clay/diluent slurry, the mixture is preferably agitated to facilitate dissolution of the polymerization catalyst into the diluent and migration of at least a portion of the polymerization catalyst between layers of the clay. Again, mixing is preferably continued until the mixture is homogenous and the clay does not significantly settle. Suitable temperatures are as stated above.

The amount of catalyst that is used can vary widely. For example, the amount of catalyst may be in the range of from about 1 to about 100, or from about 2 to about 80, or from about 3 to about 50, or about 5 to about 25 parts by weight per 100 parts by weight clay. The amount of catalyst is to some extent selected in conjunction with the level at which the catalyst-containing clay will be used in the subsequent polymerization reaction, so that desirable levels of both the clay and the catalyst are provided.

The resulting catalyst-containing clay will have a quantity of the polymerization catalyst interposed between the layers of the clay. This catalyst remains catalytically active, and thus will promote the subsequent polymerization of a macrocyclic oligomer. The catalyst may become chemically bonded to the clay itself or to an onium modifier (as described below) that is used to treat the clay. This chemical bond formation typically occurs through an active hydrogen-containing group (such as a hydroxyl or amine group) on the clay or onium ion.

The catalyst composition may in addition contain a quantity of polymerization catalyst that is deposited on the surface of the clay particles, and/or dissolved or dispersed in the diluent phase (if diluent is not removed from the slurry). The average layer spacing of the clay particles may be increased somewhat from that of the starting clay, due to swelling by the diluent, intercalation by the catalyst, or both, but this is often not apparent when smaller quantities of catalyst are used and diluent has been removed. When seen, the increase in layer spacing is typically from about 2 to about 50 angstroms, from about 2 to about 30 angstroms, from about 5 to about 25 angstroms or from about 10 to 20 angstroms. Absolute layer spacing may range from about 15 to about 65 angstroms, from about 17 to about 45 angstroms, from about 20 to about 40 angstroms or from about 25-35 angstroms. The presence of the catalyst within the layers of the clay can also be detected using X-ray fluorescence and mass spectroscopy methods on clay that is washed after being contacted with the catalyst. Both catalyst-intercalated clay and catalyst bound to the onium in the clay have been observed.

The diluent may or may not be removed from the resulting slurry before the catalyst-containing clay is combined with the macrocyclic oligomer. Diluent removal is conveniently done using conventional methods of decanting, drying, distillation, vacuum distillation, filtration, or combinations of these. Drying and distillation methods, especially vacuum drying and vacuum distillation methods, are preferred as they more readily permit complete or near-complete diluent removal.

There are several ways in which the slurry of catalyst-containing clay can be combined with a macrocyclic oligomer. In a first method, the catalyst-containing clay is mixed with a molten macrocyclic oligomer. Due to the presence of the active catalyst, the mixing should be done at as low a temperature as possible to avoid premature polymerization. For preferred macrocyclic oligomers (as described below), the temperature at which the macrocyclic oligomer is mixed with the catalyst-containing clay is preferably about 130° C. or greater, more preferably about 140° C. or greater and most preferably about 150° C. or greater, to about 190° C. or less, more preferably about 180° C. or less and most preferably about 170° C. or less. Preferably, the contacting occurs in an inert atmosphere such as in the presence of nitrogen or argon. Shear may be and preferably is applied in order to further intercalate the clay particles with the macrocyclic monomer and thus more fully disperse the clay throughout the monomer. Shear can be provided through a variety of means such as extruding, kneading or mixing. Shearing is conveniently applied for a period of about 2 minutes or greater, more preferably about 10 minutes or greater and most preferably about 15 minutes or greater, up to about 60 minutes or less, more preferably about 40 minutes or less and most preferably about 25 minutes or less. Shearing times at elevated temperatures are preferably kept as short as possible to minimize premature polymerization of the macrocyclic oligomer, and the resulting mixture of macrocyclic oligomer and catalyst-containing clay is preferably cooled to below the melting temperature of the macrocyclic oligomer when sufficient mixing is achieved. In this first method, it is preferred that the diluent be removed from catalyst-containing clay prior to mixing with the macrocyclic oligomer, although this is not critical if the diluent is not reactive with the macrocyclic oligomer. If the diluent is water, contains water (or is water-miscible) or is reactive with the macrocyclic oligomer, the catalyst-containing clay is preferably dried under elevated temperature and/or reduced pressure to remove the water or diluent. Preferably, the macrocyclic oligomer is similarly dried prior to contacting it with the catalyst-containing clay.

A second method is to blend the slurry of the catalyst-containing clay with a solution of the macrocyclic oligomer in a suitable solvent. This solvent may be the same or different as the diluent used to make the catalyst-containing clay slurry. If a different solvent is used, the two solvent and diluent are preferably miscible in each other at the relative proportions that are present. It is preferred that the same diluent is used. Use of a solution of the macrocyclic oligomer has the advantage of permitting the mixing to be performed at lower temperatures, and usually involves lower viscosity materials. The lower mixing temperatures reduce the risk of premature polymerization and provide ease of handling.

A third method is to remove the diluent from the slurry to form a dry, particulate catalyst-containing clay. This can be blended with molten macrocyclic oligomer, taking care to prevent premature polymerization as before, or can be blended with a solution the macrocyclic oligomer in a suitable solvent.

The resulting product is a dispersion of the clay particles and polymerization catalyst in the macrocyclic oligomer. A suitable concentration of clay particles is from about 1-20% by weight, based on combined weight of the clay, macrocyclic oligomers and any optional comonomers, crosslinkers or modifiers, as described more below. This level of clay provides good reinforcement and thermal properties (such heat distortion) in the polymer. Because excellent dispersion of the clay can be achieved, it is usually not necessary to use more than about 10% or about 7% by weight of the clay. A particularly preferred amount of clay is about 2-6% by weight. However, if the dispersion is to be used as a masterbatch that is blended with additional macrocyclic oligomer prior to or during the polymerization step, clay concentrations can be up to 60%, such as from about 21-60% or 25-50%, by weight, again based on the weight of the clay, macrocyclic oligomers and any optional comonomers, crosslinkers or modifiers. The dispersion desirably contains about 0.0001 to about 0.05 mole of catalyst per mole of macrocyclic oligomer, such as about 0.0005 to about 0.01 mole/mole or about 0.001 to about 0.006 mole/mole. The amount of catalyst may vary somewhat depending on the activity of the particular catalyst, and the desired rate of reaction. Again, correspondingly higher catalyst levels (such as from 3 to 10 times higher concentrations) may be present if the dispersion is to be used as a masterbatch. The catalyst level may be supplemented by additional catalyst during the polymerization step, if desired.

Any diluent that is used to make the dispersion may be removed before the polymerization step if desired, but it is possible to permit the diluent to remain and to conduct the polymerization in the presence of the diluent. In the latter case, the amount of diluent in the dispersion is suitably from about 5 to about 75% of the total weight of the dispersion, and may be from about 10 to about 60% or from about 25 to about 50% by weight. In most cases, dispersions containing levels of diluent within these ranges tend to be solid or paste-like compositions at room temperature (−22° C.). Solid dispersions and can be formed into pellets or other particulates and used in that form.

If the diluent is removed from the dispersion, various diluent flashing and extraction methods can be used. Flashing methods can be conducted above the melting temperature of the macrocyclic oligomer, and exposure times to such elevated temperatures are again desirably minimized to deter premature polymerization. Vacuum methods also can be used to remove the diluent at temperatures below the melting temperature of the polymer.

A clay-reinforced polymer composite can be formed by polymerizing the dispersion. Methods of polymerizing cyclic oligomers are well known. Examples of such methods are described in U.S. Pat. Nos. 6,369,157 and 6,420,048, WO 03/080705, and U.S. Published Application 2004/0011992, among many others. Any of these conventional polymerization methods are suitable for use with this invention.

The polymerization may be conducted neat (i.e., solventless) or in the presence of a solvent. If conducted in a solvent, the solvent may be the same as the diluent that is used to make the dispersion, or can be a different material.

Additional macrocyclic oligomer can be added to the dispersion if desired prior to polymerization.

In general, the polymerization is conducted by heating the dispersion above the melting temperature of the macrocyclic oligomer. The polymerizing mixture is maintained at the elevated temperature until the desired molecular weight is obtained. Suitable polymerization temperatures are from about 100° C. to about 300° C., with a temperature range of about 100° C. to about 280° C. being preferable and a temperature range of about 150-270° C. being especially preferred. Polymerization temperatures below 200° C. are sometimes most preferred, as it is believed that less degradation of organic materials (including onium modifiers in the clay) occurs at the lower temperatures, leading to higher conversions of oligomer to polymer.

As catalyst is already present in the dispersion, it is usually unnecessary to blend the dispersion with additional catalyst before conducting the polymerization. However, additional catalyst can be added if the dispersion does not contain the desired catalyst level.

The polymerization may be conducted in a closed mold to form a molded article. An advantage of macrocyclic oligomer polymerization processes is that they allow thermoplastic resin molding operations to be conducted using techniques that are generally applicable to thermosetting resins. When melted, the macrocyclic oligomer typically has a relatively low viscosity. This allows the macrocyclic oligomer to be used in reactive molding process such as liquid resin molding, reaction injection molding and resin transfer molding, as well as in processes such as resin film infusion, impregnation of fiber mats or fabrics, prepreg formation, pultrusion and filament winding that require the resin to penetrate between individual fibers of fiber bundles to form structural composites. Certain processes of these types are described in U.S. Pat. No. 6,420,047, incorporated herein by reference.

The resulting polymer must achieve a temperature below its crystallization temperature before it is demolded. Thus, it may be necessary to cool the polymer before demolding (or otherwise completing processing). In some instances, particularly in polymerizing cyclic butylene terephthalate oligomers, the melting and polymerization temperature of the oligomers is below the crystallization temperature of the resulting polymer. In such a case, the polymerization temperature is advantageously between the melting temperature of the oligomer and the crystallization temperature of the polymer. This allows the polymer to crystallize at the polymerization temperature (isothermal curing) as molecular weight increases. In such cases, it is not necessary to cool the polymer before demolding can occur.

The polymerization can also be conducted as a bulk or solution polymerization to produce a particulate polymer (such as a pelletized polymer) that is useful for subsequent melt processing operations such as extrusion, injection molding, compression molding, thermoforming, blow molding, resin transfer molding and the like.

The resulting composite may be further processed to increase its molecular weight. Two approaches to accomplishing this are solid state polymerization and chain extension. Solid state polymerization is achieved by postcuring the composite by exposing it to an elevated temperature. A suitable postcuring temperature is from about 170° C., about 180° C., or about 195° C. up to about 220° C., about 210° C. or about 205° C., but below the melting temperature of the polymer phase of the nanocomposite. The solid state polymerization is preferably performed in a non-oxidizing environment such as under a nitrogen or argon atmosphere and is preferably performed under vacuum and/or flowing gas to remove volatile by-products. Postcuring time times of about 1-36 hours, such as from 4-30 hours or 12-24 hours are generally suitable. Preferably, the macrocyclic oligomer is advanced to a weight average molecular weight of about 60,000 or greater, more preferably about 80,000 or greater and most preferably about 100,000 or greater. It is usually not necessary to use additional catalyst to obtain solid state advancement.

Chain extension is performed by contacting the nanocomposite with a polyfunctional chain extending agent. The polyfunctional chain extending agent contains two or more functional groups that react with functional groups on the polymerized macrocyclic oligomer to couple polymer chains and thus increase molecular weight. Suitable such polyfunctional chain extending agents are described more fully below. No additional catalyst is usually required and elevated temperatures as described hereinbefore are used for the chain extension.

Clays that are useful in this invention are minerals or synthetic materials having a layered structure, in which the individual layers are platelets or fibers with thicknesses in the range of 5-100 angstroms. Suitable clays include kaolinite, halloysite, serpentine, montmorillonite, beidellite, nontronite, hectorite, stevensite, saponite, illite, kenyaite, magadiite, muscovite, sauconite, vermiculite, volkonskoite, pyrophylite, mica, chlorite or smectite. Preferably, the clay comprises a natural or synthetic clay of the kaolinite, mica, vermiculite, hormite, illite or montmorillonite groups. Preferred kaolinite group clays include kaolinite, halloysite, dickite, nacrite and the like. Preferred montmorillonites include montmorillonite, nontronite, beidellite, hectorite, saponite, bentonite and the like. Preferred minerals of the illite group include hydromicas, phengite, brammalite, glauconite, celadonite and the like. More preferably, the preferred layered minerals include those often referred to as 2:1 layered silicate minerals like muscovite, vermiculite, beidelite, saponite, hectorite and montmorillonite, wherein montmorillonite is most preferred. Preferred minerals of the hormite group include sepiolite and attapulgite, wherein the layered structure is interrupted in one dimension resulting in a fibrous or lath-like particle morphology.

The clay is generally in the form of particles having a smallest dimension of about 0.6 nanometers or greater and preferably about 1 nanometer or greater, up to about 50 nanometers, more preferably up to about 20 nanometers, and especially up to about 10 nanometers. The particles may have a largest dimension of up to 1 micron or more. Particle sizes in this invention refer to volume average particle sizes of the dispersed filler particles, measured using an appropriate analytical method such as transmission electron spectroscopy, not simply to the as-received filler, which may be in the form of aggregated primary particles, or may have a layered structure that is often subdivided into smaller materials during the process of making the masterbatch and/or composite.

Preferably, the clay particles have an aspect ratio of about 10 or greater, more preferably about 100 or greater and most preferably about 500 or greater. “Aspect ratio” as used herein means the length of the largest dimension of a platelet or fiber divided by the smallest dimension, which is preferably the platelet or fiber thickness.

In addition to the clays mentioned above, admixtures prepared therefrom may also be employed as well as accessory minerals including, for instance, quartz, biotite, limonite, hydrous micas, feldspar and the like. The layered minerals described above may be synthetically produced by a variety of processes, and are known as synthetic hectorites, saponites, montmorillonites, micas as well as their fluorinated analogs. Synthetic clays can be prepared via a number of methods which include the hydrolysis and hydration of silicates, gas solid reactions between talc and alkali fluorosilicates, high temperature melts of oxides and fluorides, hydrothermal reactions of fluorides and hydroxides, shale weathering as well as the action of acid clays, humus and inorganic acids on primary silicates.

The clay is preferably modified with an organic onium compound, such as described in U.S. Pat. No. 6,707,439 and PCT/US03/041,476. This modification results in a cation exchange reaction with the native clay, substituting the organic onium compound for mainly alkali metal and alkaline earth cations present in the unmodified clay. The onium compound is a salt comprising a negatively-charged counter-ion and a positively-charged nitrogen-, phosphorus- or sulfur-containing group. Particularly useful onium compounds have at least one ligand with a five carbon atom or greater chain. Preferably, the onium compound has at least one ligand with a five carbon atom or greater chain, and at least one (and preferably two or more) other ligand that contains a functional group having an active hydrogen atom capable of reacting with the macrocyclic oligomer during the polymerization reaction. The active hydrogen-containing group is in some instances believed to react with the polymerization catalyst to bond the catalyst to the clay structure. The counter ion in the onium compound can be any anion which forms a salt with an onium compound and which can be exchanged with an anionic species on the clay particle. Preferably the onium compound corresponds to the formula 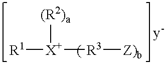
wherein R¹ is a C₅ or greater straight, alicyclic or branched chain hydrocarbyl group, R² is independently in each occurrence a C₁₋₂₀ hydrocarbyl group optionally containing one or more heteroatoms; R³ is a C₁₋₂₀ alkylene or cycloalkylene moiety; X is a nitrogen, phosphorus or sulfur; Z is an active hydrogen atom-containing functional group; a is separately in each occurrence an integer of 0, 1 or 2 and b is an integer of 1 to 3 wherein the sum of a+b is 2 where X is sulfur and 3 where X is nitrogen or phosphorus. More preferably X is nitrogen. More preferably, R¹ is a C¹⁰⁻²⁰ hydrocarbon chain; and most preferably a C₁₂₋₁₈ alkyl group. More preferably, R² is C₁₋₁₀ hydrocarbyl and most preferably C₁₋₃ alkyl. More preferably, R³ is C₁₋₁₀ alkylene and most preferably C₁₋₃ alkylene. More preferably, Z is a primary or secondary amine, thiol, hydroxyl, acid chloride or carboxylic acid, carboxylate ester or glycidyl group; even more preferably a primary amine or hydroxyl group and most preferably a hydroxyl group. More preferably, y is separately in each occurrence a halogen or sulfate ester (such as an alkyl sulfate like methyl sulfate), and most preferably chlorine or bromine. More preferably, a is an integer of 0 or 1, and most preferably 1. Most preferably, b is 2 or 3.

Other onium compounds that do not contain the active-hydrogen containing functional group can be used instead of or in combination with those described above. Suitable examples of these include those described in U.S. Pat. No. 5,530,052 and U.S. Pat. No. 5,707,439, incorporated herein by reference. When such non-functional onium compounds are used, they are preferably used in combination with the functional types. The onium compounds containing functional groups tend to act as initiation sites for polymerization of the macrocyclic oligomers. The presence of these initiation sites tends to increase the number of polymer chains that are formed, which in turn tends to reduce average molecular weight of the polymer. Using a mixture of the functional and non-functional types permits one to balance molecular weight effects with good dispersion of the clay into the polymer matrix. Preferably, the functional onium compound constitutes at least 1 weight percent or greater, such as at least 10 weight percent or at least 20 weight percent, about 100 percent by weight, such as up to about 90 weight percent or up to about 50 weight percent up to about 30 weight percent of all onium compounds used.

The onium compounds tend to enhance the ability of the catalyst and macrocylic oligomer to intercalate the clay. Preferably, at least 50 percent, such as at least 75 percent or at least 90 percent of the exchangeable cations on the clay are replaced with the onium compound. An excess of the onium compound, such as up to 1.5 equivalents or 1.25 equivalents of onium compound per equivalent of exchangeable cations, may be used.

The masterbatch may include one or more polymerization catalysts for the macrocyclic oligomer and/or other polymerizable materials that are either present in the masterbatch or which will be subsequently blended with the masterbatch. Tin- or titanate-based polymerization catalysts are of particular interest. Examples of such catalysts are described in U.S. Pat. No. 6,498,651 and U.S. Pat. No. 5,547,984, the disclosures of which are incorporated herein by reference. One or more catalysts may be used together or sequentially.

Illustrative examples of classes of tin compounds that may be used in the invention include monoalkyltin hydroxide oxides, monoalkyltinchloride dihydroxides, dialkyltin oxides, bistrialkyltin oxides, monoalkyltin trisalkoxides, dialkyltin dialkoxides, trialkyltin alkoxides, tin compounds having the formula and tin compounds having the formula 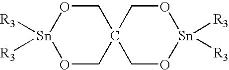
wherein R₂ is a C₁₋₄ primary alkyl group, and R³ is C₁₋₁₀ alkyl group. Specific examples of organotin compounds that may be used in this invention include, 1,1,6,6-tetra-n-butyl-1,6-distanna-2,5,7-10-tetraoxacyclodecane, n-butyltinchloride dihydroxide, di-n-butyltin oxide, di-n-octyltin oxide, n-butyltin tri-n-butoxide, di-n-butyltin di-n-butoxide, 2,2-di-n-butyl-2-stanna-1,3-dioxacycloheptane, and tributyltin ethoxide. In addition, tin catalysts described in U.S. Pat. No. 6,420,047 (incorporated by reference) may be used in the polymerization reaction.

Titanate compounds that may be used in the invention include described in U.S. Pat. No. 6,420,047 (incorporated by reference). Illustrative examples include tetraalkyl titanates (e.g., tetra(2-ethylhexyl) titanate, tetraisopropyl titanate, and tetrabutyl titanate), isopropyl titanate, titanate tetraalkoxide. Other illustrative examples include (a) titanate compounds having the formula 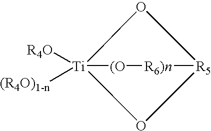
wherein each R₄ is independently an alkyl group, or the two R₄ groups taken together form a divalent aliphatic hydrocarbon group; R₅ is a C₂₋₁₀ divalent or trivalent aliphatic hydrocarbon group; R₆ is a methylene or ethylene group; and n is 0 or 1, (b) titanate ester compounds having at least one moiety of the formula 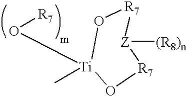
wherein each R₇ is independently a C₂₋₃ alkylene group; Z is O or N; R₈ is a C₁₋₆ alkyl group or unsubstituted or substituted phenyl group; provided when Z is O, m−n−0, and when Z is N, m=0 or 1 and m+n=1, and (c) titanate ester compounds having at least one moiety of the formula 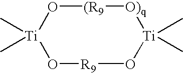
wherein each R₉ is independently a C₂₋₆ alkylene group; and q is 0 or 1.

Other suitable polymerization catalysts can be represented as
RₙQ₍₃₋ₙ₎Sn—O—X (I)
where n is 2 or 3, each R is independently an inertly substituted hydrocarbyl group, Q is an anionic ligand, and X is a group having a tin, zinc, aluminum or titanium atom bonded directed to the adjacent oxygen atom. Suitable X groups include —SnRₙQ₍₃₋ₙ₎, where R, Q and n are as described before; —ZnQ, where Q is as described before, —Ti(O)₃, where Q is as described before, and —AlRₚ(Q)₍₂₋ₚ₎, where R is as described before and p is zero, 1 or 2. Preferred Q groups include —OR groups, where R is as described above. When X is SnRₙQ₍₃₋ₙ₎, R and/or OR groups may be divalent radicals that form ring structures including one or more of the tin or other metal atoms in the catalyst. Preferred X groups are —SnRₙQ₍₃₋ₙ₎, —Ti(OR)₃ and —AlRₚ(OR)₍₂₋ₚ₎. n is preferably 1 or 2. These catalysts are described in more detail in U.S. Provisional Application 60/564,552, filed Apr. 22, 2004. Examples of particular polymerization catalysts of this type include 1,3-dichloro-1,1,3,3-tetrabutyldistannoxane; 1,3-dibromo-1,1,3,3-tetrabutyldistannoxane; 1,3-difloro-1,1,3,3-tetrabutyldistannoxane; 1,3-diacetyl-1,1,3,3-tetrabutyldistannoxane; 1-chloro-3-methoxy-1,1,3,3-tetrabutyldistannoxane; 1,3-methoxy-1,1,3,3-tetrabutyl distannoxane; 1,3-ethoxy-1, 1,3,3-tetrabutyldistannoxane; 1,3-(1,2-glycolate)-1,1,3,3-tetrabutyldistannoxane; 1,3-dichloro-1,1,3,3-tetraphenyldistannoxane; (n-butyl)₂(ethoxy)Sn—O—Al(ethoxide)₂, (n-butyl)₂(methoxy)Sn—O—Zn(methoxide), (n-butyl)₂(i-propoxy)Sn—O—Ti(i-propoxide)₃, (n-butyl)₃Sn—O—Al(ethyl)₂, (t-butyl)₂(ethoxy)Sn—O—Al(ethoxide)₂, and the like. Suitable distannoxane catalysts (i.e., where m is zero and X is —SnRₙQ₍₃₋ₙ₎) are described in U.S. Pat. No. 6,350,850, incorporated herein by reference.

Enough catalyst is provided to provide a desirable polymerization rate and to obtain the desired conversion of oligomers to polymer, but it is usually desirable to avoid using excessive amounts of catalyst. A suitable mole ratio of transesterification catalyst to macrocyclic oligomer can range from about 0.01 mole percent or greater, more preferably from about 0.1 mole percent or greater and more preferably 0.2 mole percent or greater. The mole ratio of transesterification catalyst to macrocyclic oligomer is from about 10 mole percent or less, more preferably 2 mole percent or less, even more preferably about 1 mole percent or less and most preferably 0.6 mole percent or less.

The macrocyclic oligomer is a polymerizable cyclic material having two or more ester linkages in a ring structure. The ring structure containing the ester linkages includes at least 8 atoms that are bonded together to form the ring. The oligomer includes two or more structural repeat units that are connected through the ester linkages. The structural repeat units may be the same or different. The number of repeat units in the oligomer suitable ranges from about 2 to about 8. Commonly, the macrocyclic oligomer will include a mixture of materials having varying numbers of repeat units. A preferred class of macrocyclic oligomers is represented by the structure
—[O-A-O—C(O)—B—C(O)]_{y}— (I)
where A is a divalent alkyl, divalent cycloalkyl or divalent mono- or polyoxyalkylene group, B is a divalent aromatic or divalent alicyclic group, and y is a number from 2 to 8. The bonds indicated at the ends of structure I connect to form a ring. Examples of suitable macrocyclic oligomers corresponding to structure I include oligomers of 1,4-butylene terephthalate, 1,3-propylene terephthalate, 1,4-cyclohexenedimethylene terephthalate, ethylene terephthalate, and 1,2-ethylene-2,6-naphthalenedicarboxylate, and copolyester oligomers comprising two or more of these. The macrocyclic oligomer is preferably one having a melting temperature of below about 200° C. and preferably in the range of about 150-190° C. A particularly preferred macrocyclic oligomer is a 1,4-butylene terephthalate oligomer.

Suitable methods of preparing the macrocyclic oligomer are described in U.S. Pat. Nos. 5,039,783, 6,369,157 and 6,525,164, WO 02/18476 and WO03/031059, all incorporated herein by reference. In general, macrocyclic oligomers are suitably prepared by reacting a diol with a diacid, diacid chloride or diester, or by depolymerization of a linear polyester. The method of preparing the macrocyclic oligomer is generally not critical to this invention.

The diluent is any which swells the clay, dissolves the catalyst, and is otherwise inert to each (i.e., does not undesirably react with the clay or the catalyst). Suitable diluents include chlorinated hydrocarbons such as orthodichlorobenzene, hydrocarbons, high boiling ethers, esters and ketones. Ketone and ester diluents should not be types that are reactive with the macrocyclic oligomer, comonomers or modifiers, if the diluent is not to be removed prior to contacting the catalyst-containing clay with those materials.

Various additional materials may be incorporated into the dispersion of the catalyst-containing clay and macrocyclic oligomer. One such material is a copolymerizable monomer, other than a macrocylic oligomer, which will copolymerize with the macrocyclic oligomer to form a random or block copolymer. Suitable copolymerizable monomers include cyclic esters such as lactones. The lactone conveniently contains a 4-7 member ring containing one or more ester linkages. The lactone may be substituted or unsubstituted. Suitable substituent groups include halogen, alkyl, aryl, alkoxyl, cyano, ether, sulfide or tertiary amine groups. Substituent groups preferably are not reactive with an ester group in such a way that they can cause the comonomer to function as an initiator compound. Examples of such copolymerizable monomers include glycolide, dioxanone, 1,4-dioxane-2,3-dione, ε-caprolactone, tetramethyl glycolide, β-butyrolactone, lactide, γ-butyrolactone and pivalolactone.

Another optional material that may be included is a polyfunctional chain extending compound having two or more functional groups which will react with functional groups on the polymerized macrocyclic oligomer (and/or another polymer in the blend). Examples of suitable functional groups are epoxy, isocyanate, ester, hydroxyl, carboxylic acid, carboxylic acid anhydride or carboxylic acid halide groups. More preferably, the functional groups are isocyanate or epoxy, with epoxy functional groups being most preferred. Preferred epoxy-containing chain extenders are aliphatic or aromatic glycidyl ethers. Preferable isocyanate-containing chain extenders include both aromatic and aliphatic diisocyanates. Preferably, the chain extender has about 2 to about 4, more preferably about 2 to about 3 and most preferably about 2 such functional groups per molecule, on average. The chain extender material suitably has an equivalent weight per functional group of 500 or less. A suitable amount of chain extender provides, for example, at least 0.25 mole of functional groups per mole of reactive groups in the polymerized macrocyclic oligomer.

Another optional material is one or more polymeric materials which will form a polymer blend with the polymerized macrocyclic oligomer during its subsequent polymerization. Examples of such polymeric materials include, for example, polyesters such as poly(ε-caprolactam), polybutylene terephthalate, polyethylene adipate, polyethylene terephthalate and the like, polyamides, polycarbonates, polyurethanes, polyether polyols, polyester polyols, and amine-functional polyethers and/polyesters. Polyolefins (such as polymers and interpolymers of ethylene, propylene, a butylene isomer and/or other polymerizable alkenes) that contain functional groups that react with functional groups on the polymerized macrocyclic oligomer and/or a chain extending agent can be used. Other polymeric materials that are compatible with the macrocyclic oligomer and/or the polymerized macrocyclic oligomer or contain functional groups that permit them to be coupled to the polymerized macrocyclic oligomer are also useful. Certain of these polymers may engage in transesterification reactions with the macrocyclic oligomer or its polymer during the polymerization process, to form block copolymers. Polymeric materials having reactive functional groups may be coupled to the polymerized macrocyclic oligomer with chain extenders as described above. Suitable functionalized polymeric materials contain about 1 or more, more preferably about 2 to about 3 and most preferably about 2 such functional groups per molecule, on average, and have an equivalent weight per functional group of greater than 500. Their molecular weights are suitably up to about 100,000, such as up to about 20,000 or up to about 10,000. Preferably, the polymeric material has a glass transition temperature significantly lower (such at least 10° C. lower or at least 30° C. lower) than the glass transition temperature of the polymerized macrocyclic oligomer alone. The lower glass transition temperature polymeric materials tend to improve the ductility and impact resistance of the resulting product. The functionalized polymer can contain any backbone which achieves the desired results of this invention. An especially suitable polyfunctional polymer is a polyether or polyester polyol.

Another suitable additional material is an impact modifier. Any impact modifier which improves the impact properties and toughness of the polymer composition may be used. Examples of impact modifiers include core-shell rubbers, olefinic toughening agents, block copolymers of monovinylidene aromatic compounds and alkadienes and ethylene-propylene diene monomer based polymers. The impact modifiers can be unfunctionalized or functionalized with polar functional groups. Suitable core shell rubbers include functionalized core-shell rubbers having surface functional groups that react with the macrocyclic oligomer or functional groups on the polymerized macrocyclic oligomers. Preferred functional groups are glycidyl ether moieties or glycidyl acrylate moieties. The core-shell rubber will generally contain about 30 to about 90 percent by weight core, where “core” refers to the central, elastomeric portion of the core-shell rubber. The core-shell rubber may be added after the polymerization is complete, in a high shear environment such as an extruder.

A natural or synthetic rubber is another type of modifier that is useful and may be added to the composition. Rubber is generally added to improve the toughness of the polymer. Rubber modified polymers according to the invention desirable exhibit a dart impact strength (according to ASTM D3763-99) of about 50 inch-lbs or greater, more preferably about 150 inch-lbs or greater and most preferably about 300 inch-lbs or greater.

In addition to the previously-described chain extenders and modifiers, various kinds of optional materials may be incorporated into the polymerization process. Examples of such materials include reinforcing agents (such as glass, carbon or other fibers), flame retardants, colorants, antioxidants, preservatives, mold release agents, lubricants, UV stabilizers, and the like.

The following examples are provided to illustrate the invention, but are not intended to limit the scope thereof. All parts and percentages are by weight unless otherwise indicated.

### EXAMPLES 1-4

Dispersions of catalyst-containing clay in cyclic butylene terephthalate oligomers are prepared in the following general manner:

First, 0.25 parts of the clay are weighed into a glass vial. 10 parts of methylene chloride are added, and the mixture shaken until a translucent suspension is obtained that does not settle upon standing. Approximately 0.02 parts of 1,3-dichloro-1,3-di-n-butyldistannoxane catalyst are then added to the suspension and the mixture shaken again. The precise amount of catalyst that is added is sufficient to provide 0.15 mole of catalyst per mole oligomers when the catalyst-containing clay is mixed with 4.73 g of cyclic butylene terephthalate oligomers. After shaking for a short period, the diluent is evaporated and the resulting particulate is dried.

The clays used in Examples 1-4 are:

TABLE 1

| Example No. | Clay Chemistry | Clay Name |
|---|---|---|
| 1 | Cocoalkyl, methyl, | Somasif ™ MEE |
| | bishydroxyethyl ammonium- | |
| | modified fluoromica | |
| 2 | Tallow alkyl, methyl, | Cloisite ™ 30B |
| | bishydroxyethyl ammonium- | |
| | modified montmorillonite | |
| 3 | Dimethyl, hydrogenated tallow | Somasif ™ Arquad |
| | alkyl, benzylammonium- | DMHTB |
| | modified fluoromica | |
| 4 | Octadecylammonium-modified | Armeen ™ 18D |
| | fluoromica | |

The catalyst-containing clays are melt blended with 4.73 parts of cyclic butylene terephthalate oligomers at a temperature above the melting temperature of the oligomers, to form a dispersion containing about 5% by weight dispersed clay and 0.15 mole catalyst/mole oligomers.

Polymerizations are conducted under a nitrogen atmosphere in an Advanced Rheometric Expansion System (Rheometric Scientific) dynamic mechanical spectrometer using RSI Orchestrator software. The device is equipped with custom-made aluminum cup-and-plate fixtures. The diameters of the cup and plate are 25 and 7.9 mm, respectively. Approximately 3 g of dried cyclic butylene terephthalate oligomer/catalyst mixture is charged into the cup, which is preheated to ˜160° C. After the heat melts the oligomer in the mixture, the upper plate is lowered to contact the surface of the molten oligomer, and the distance between the cup and plate is measured. The temperature of the plate, cup, and mixture are warmed rapidly to 190° C., and held at 190° C. to monitor the polymerization of the oligomers.

Low-strain amplitude oscillations are imposed on the contents of the cup via an actuator attached to the cup. The actuator forces the cup to oscillate sinusoidally in a twisting motion about the vertical axis. Some of this energy is transmitted to the plate through the sample, causing the plate to twist sinusoidally. The complex shear viscosity η* of the sample is estimated from the amplitude of the cup angular displacement, the amplitude of the torque on the plate, the phase lag of the plate relative to the cup, the angular frequency of the sinusoidal signals, and the sample dimensions. The magnitude |η*| of the complex shear viscosity is a key metric of the progress of the polymerization, and is henceforth simply referred to as the viscosity. This method provides good estimates of viscosity increases from about 20 poises to somewhat in excess of about 10,000 poises, and allows the progress of the polymerization to be followed.

All of Examples 1-4 show an onset of polymerization after approximately one minute and all display a rate of polymerization after onset very similar to that of a control containing no clay. This establishes the activity of the catalyst in the intercalated clays.

### EXAMPLE 5

Example 1 is repeated, this time using 2 parts of catalyst for each 3 parts by weight of clay. An X-ray diffraction pattern is taken on the dried catalyst-containing clay. Interlayer distances in the catalyst-containing clay are measured at approximately 30 angstroms, about double that for the untreated clay, confirming that the catalyst does penetrate between the layers of the clay.

### EXAMPLE 6

Dibutyltin oxide (0.038 g) and Somasif™ MEE (0.5 g) are refluxed in 50 ml toluene for 3 hours to form a catalyst-containing clay. After the mixture is allowed to cool to room temperature, 9.46 g of cyclic butylene terephthalate are added with stirring. Toluene is removed by vacuum oven drying at 90° C. The resultant dry powder is then polymerized at 190° C. for about 1 hour. Mass spectrometry data indicates the presence of a new, covalently bonded tin-onium complex. This species shows polymerization activity and the polymerized nanocomposite shows good clay dispersion as analyzed with both X-ray diffraction and TEM.

### EXAMPLES 7 AND 8

A powder mixture of Somasif MEE™ clay, 1,1,6,6-tetra-n-butyl-1,6-distanna-2,5,7-10-tetraoxacyclodecane and cyclic butylene tererphthalate oligomer is dry blended and treated in a vacuum oven overnight at 80° C. A masterbatch of this composition is prepared by feeding the powder mixture into an 18-mm Leistritz co-rotating twin screw extruder operated at 170° C. at 5 lbs/hr. The melted extrudates are solidified, granulated, crystallized, and stored. X-ray diffraction shows that the masterbatches contain oligomer-intercalated clay, as evidenced by the increase in the interlayer spacing of the clay in the masterbatch compared to the initial value in the clay. X-ray fluorescence data of the extracted sample show that tin remains bound to the clay.

Example 8 is prepared as above, except the clay concentration is increased three-fold.

### EXAMPLES 9-11

Compositions are prepared from Example 7 by a reactive extrusion (REX) process. The REX process is run on a co-rotating twin screw extruder (Werner Pfleiderer and Krupp, 25 mm, 38 LID) equipped with a gear pump, a 1″ static mixer (Kenics), a 2.5″ filter (80/325/80 mesh) and a two hole die downstream. The extruder is run at 10 pounds (4.5 kg)/hour with an average residence time of 7.5 minutes. Granulated masterbatches and (macrocyclic oligomer/distannoxane catalyst mixtures) are dried in a vacuum oven at 90° C. for at least 8 hours before using. These are separately fed into the feed throat of the extruder using vibratory feeders. The feeders and hopper are padded with inert gas during operation. The extruder is operated at 120° C. in the initial zones, with downstream zones at 170° C. and the additional downstream equipment at 250° C. The stranded polymer extruded from the die is air cooled and chopped in a pelletizer. The extruded pellets are then solid state advanced in a vacuum oven for 8 hours at 200° C. Test bars are molded using a 28 ton Arburg press, using a 260° C. barrel temperature and 88° C. mold temperature. Mechanical and thermal properties of the resulting moldings (Example 9) are acquired using standard testing methods and are as tabulated in Table 2.

Polymer Example 10 is made in the same manner as Example 9, except the masterbatch of Example 7 is let down into cyclic butylene terephthalate oligomer and butyltinchloridedihydroxide is used as the polymerization catalyst. Results are as given in Table 2.

Polymer Example 11 is prepared in the same manner as Example 9, except that masterbatch Example 8 is let down into cyclic butylene terephthalate oligomer without added catalyst. Results are as indicated in Table 2.

TABLE 2

| | | | Dart Impact | |
|---|---|---|---|---|
| | Tensile | | lb-in (N-m), | |
| Example | Modulus, | CLTE, | room | |
| No. | psi (GPa) | cm/cm/C. ×10⁻⁶ | temperature | |
| 9 | 489,000 (3.37) | 84 | 45 | (5.1) |
| 10 | 501,000 (3.45) | 79 | 488 | (55.1) |
| 11 | 488,000 (3.36) | 85 | 15 | (1.7) |

It will be appreciated that many modifications can be made to the invention as described herein without departing from the spirit of the invention, the scope of which is defined by the appended claims.

What is claimed is:

1. A process for preparing a nanocomposite of clay platelets in a polymer of a macrocyclic oligomer, comprising
a) forming a catalyst-containing layered clay;
b) combining the catalyst-containing layered clay with a macrocyclic oligomer;
c) polymerizing the macrocyclic oligomer in the presence of the catalyst-containing clay.

2. The process of claim 1, wherein the clay has a smallest dimension of about 0.6 nanometers up to about 50 nanometers.

3. The process of claim 1, wherein the catalyst is a tin or titanate compound or mixture of two or more tin or titanate compounds.

4. The process of claim 1, wherein the macrocyclic oligomer is an oligomer of 1,4-butylene terephthalate, 1,3-propylene terephthalate, 1,4-cyclohexenedimethylene terephthalate, ethylene terephthalate, and 1,2-ethylene-2,6-naphthalenedicarboxylate, or an oligomer of two or more thereof.

5. The process of claim 4, wherein step b) is conducted in the presence of a diluent.

6. A layered clay containing a macrocyclic oligomer polymerization catalyst.

7. The layered clay of claim 6, wherein the clay has a smallest dimension of about 0.6 nanometers up to about 50 nanometers.

8. The layered clay of claim 6, wherein the catalyst is a tin or titanate compound or mixture of two or more tin or titanate compounds.

9. The layered clay of claim 8, further comprising a diluent.

10. The layered clay of claim 6, where at least a portion of the catalyst is intercalated in the layers of the clay.

11. The layered clay of claim 6, wherein at least a portion of the catalyst is chemically bonded to the clay.

12. The layered clay of claim 6, wherein the clay contains an organic onium compound.

13. The layered clay of claim 12, wherein the catalyst is chemically bonded to the onium compound.

14. A method of forming a catalyst-containing layered clay, comprising contacting the clay with a macrocyclic oligomer polymerization catalyst in the presence of a diluent that swells the clay but is otherwise inert to the clay.

15. The method of claim 14, wherein the clay has a smallest dimension of about 0.6 nanometers up to about 50 nanometers.

16. The method of claim 14, wherein the catalyst is a tin or titanate compound or mixture of two or more tin or titanate compounds.

17. The method of claim 14, where at least a portion of the catalyst becomes intercalated in the layers of the clay.

18. The method of claim 14, wherein at least a portion of the catalyst becomes chemically bonded to the clay.

19. The method of claim 14, wherein the clay contains an organic onium compound.

20. The method of claim 19, wherein the catalyst is chemically bonded to the onium compound.
